(19) United States
(12) Patent Application Publication
(10) Pub. No.: US 2003/0038965 A1
(43) Pub. Date: Feb. 27, 2003

(54) Private printing using network-based imaging

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Adminstration, P.O. Box 272400, Fort Collins, CO, 80527-2400, US

(21) Appl. No.: 09/941,038

(22) Filed: Aug. 27, 2001

(51) Int. Cl. B41J 1/00; G06F 15/00; H04N 1/00

(52) U.S. Cl. 358/1.15; 358/402

(57) ABSTRACT

Private printing using network-based imaging allows a user of a client computing device to select an option to enable private printing via a network service or web page. Additionally, in accordance with another aspect of the private printing, both an identification of a user and a print request is received at a network service representing a printer. The printer then waits to print the requested document until the user is in close physical proximity to the printer.

### TECHNICAL FIELD

This invention relates to printing and distributed environments, and more particularly to private printing using network-based imaging.

### BACKGROUND

As computer technology has advanced, the role of computers in our daily lives has expanded, as has the need for various peripheral or supporting devices. One typical peripheral device used with computers is a printer, which generates a hard copy of data that is used by the computer. The types and capabilities of printers available have similarly been expanding, resulting in a wide variety of printers with a range of printing capabilities, performance, and price.

One significant expansion in the use of computer technology is the networking of computers together. Networking computers together allows the computers to communicate with one another as well as with other devices, such as printers. This has numerous benefits, including reduced equipment costs by allowing users of multiple computers to share (e.g., print to) a single printer.

However, one problem encountered with networking multiple computers together to share a printer is that in such situations the printer typically is not in close physical proximity to all of the users that will be printing to it. This can create privacy concerns for some users who do not want the documents they print to be seen by other users, such as documents containing payroll information, documents containing annual employee review documents, etc.

Furthermore, typically in order for a user of a computer to print to particular printers on a network software must be installed on the computer that allows it to configure the printer for printing and communicate print requests to the printer. Such software is commonly referred to as a “printer driver”. A different printer driver is typically required for each different type (e.g., make and model) of printer that the user desires to print to. This can create many problems for a user—the user (or an administrator) must spend the time and effort to install the printer driver on the user's computer for each type of printer that the user will print to, the user is not able to move to another computer and print from that computer unless the correct printer drivers have been installed on the other computer, and so on.

It would thus be beneficial to provide a way to improve the user's ability to configure printers in a user-friendly manner, while at the same time addressing privacy concerns raised by sharing networked printers.

### SUMMARY

Private printing using network-based imaging is described herein.

In accordance with one aspect of the private printing, a user of a client computing device is able to select an option to enable private printing on a printer via a web page or network service.

In accordance with another aspect of the private printing, both an identification of a user and a print request is received at a network service representing a printer. The printer waits to print the requested document until the user is in close physical proximity to the printer.

### BRIEF DESCRIPTION OF THE DRAWINGS

FIG. 1 illustrates an exemplary distributed system in which private printing can be used.

FIG. 2 illustrates an exemplary distributed system illustrating the use of private printing in a distributed environment in additional detail.

FIG. 3 illustrates an exemplary web-based architecture in which private printing can be used.

FIG. 4 illustrates an exemplary system in which a user's close proximity to a printer is automatically detected.

FIG. 5 illustrates an exemplary user interface presented by a web browser.

FIG. 6 illustrates an exemplary printer configuration setup user interface.

FIG. 7 is a flowchart illustrating an exemplary process for configuring private printing.

FIG. 8 is a flowchart illustrating an exemplary process for printing using private printing.

FIG. 9 is a flowchart illustrating an exemplary process for automated printing using private printing.

FIG. 10 illustrates an exemplary computer system in additional detail.

### DETAILED DESCRIPTION

Private printing using network-based imaging is described herein. Private printing can be enabled, and optionally a personal identification number (PIN) for private printing set, via a network service representing a printer. The service allows such enabling and setting even though the computing device being used by the user has no printer driver installed for the particular printer. Once the user enters a print request via the computing device, the printer does not print the requested document(s) until the user is close-by the printer. This proximity to the printer can be determined based on inputs to the printer by the user (e.g., selection of a particular button or input of the appropriate PIN), based on a proximity sensor identifying the user as being in close proximity (e.g., based on an identification badge or other device worn by the user), combinations thereof, and so forth.

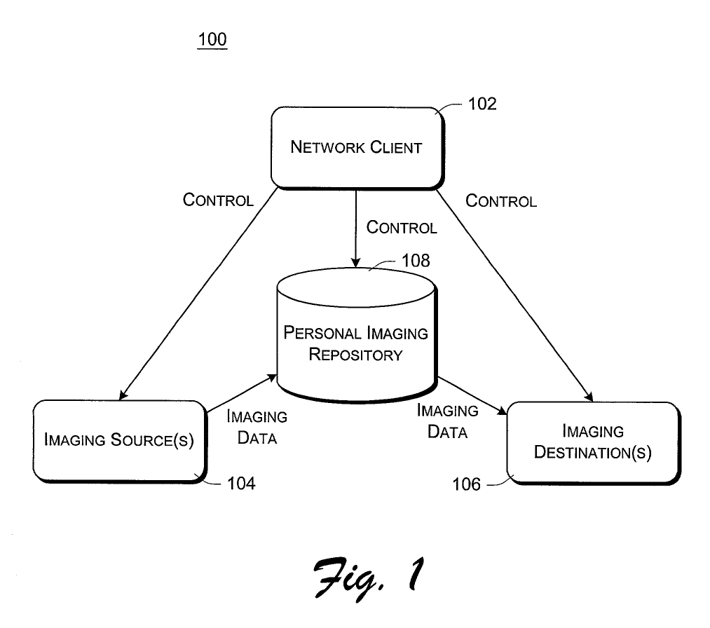

FIG. 1 illustrates an exemplary distributed system 100 in which private printing can be used. In system 100, a network client device 102 is in communication with one or more imaging sources 104, one or more imaging destinations 106, and a personal imaging repository 108. A user of client device 102 can communicate with imaging source(s) 104 to select or identify images to be stored in personal imaging repository 108. Imaging sources 104 represent any of a wide variety of devices that are capable of providing images to other devices. Examples of imaging sources 104 include computers, cameras (e.g., digital still or video cameras), scanners, applications, web sites, and so forth.

Repository 108 represents image storage facilities personalized to the individual user, although alternatively multiple users may have access to the same repository 108. Repository 108 is maintained on one or more computers, such as network client 102, an imaging source(s) 104, an imaging destination(s) 106, another computer (not shown), or combinations thereof. The “images” or “graphics” in repository 108 can be any type of printable data, such as text, drawings, frames of video or animations, pictures, combinations thereof, and so forth.

The user, via network client 102, can select images from imaging repository 108 to be communicated to imaging destination(s) 106 for printing in accordance with print option configurations identified by the user. Imaging destination 106 represents any of a wide variety of devices that are capable of processing images in some manner. Examples of imaging destinations 106 include printers, plotters, services managing printing devices, and so on.

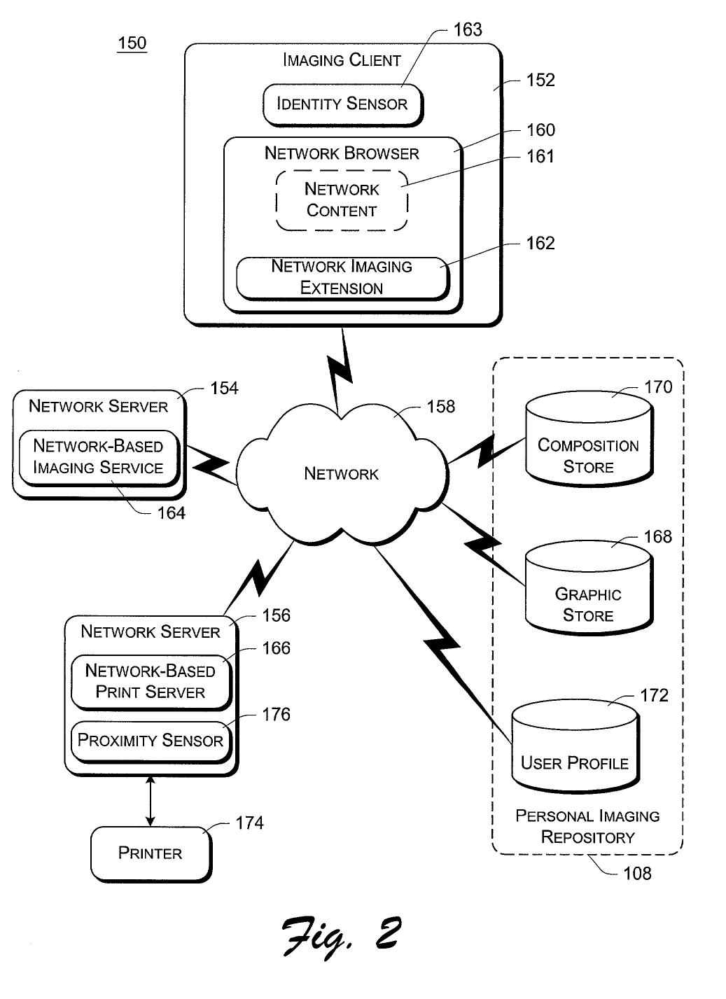

FIG. 2 illustrates an exemplary distributed system 150 illustrating the use of private printing in a distributed environment in additional detail. System 150 includes an imaging client 152 coupled to multiple network servers 154 and 156 via a network 158. Client 152 and servers 154 and 156 represent any of a wide variety of conventional wired and/or wireless computing devices, such as desktop computers, portable computers, dedicated server computers, multi-processor computing devices, cellular telephones, personal digital assistants (PDAs), handheld or pen-based computers, gaming consoles, and so forth.

Network 158 represents one or more conventional data distribution networks that can be used to communicate data and other information (e.g., control information) between or among various computing devices. Examples of network 158 include the Internet, a local area network (LAN), a public or private wide area network (WAN), combinations thereof, and so on. Network 158 can include multiple different types of networks, including wired and/or wireless portions, employing any of a wide variety of different communications protocols, including public and/or proprietary communications protocols.

During operation, a network browser 160 executing on imaging client 152 allows a user of client 152 to interact with network servers 154 and 156, as well as network services executing on such servers. Network browser 160 includes a network imaging extension 162 that allows network content 161 executing in browser 160 to communicate with the user's personal imaging repository 108, which may include communication with services via network 158. As used herein, services refer to software components that can execute on one or more computing devices and are accessible to provide functionality to imaging client 152, such as imaging sources, imaging destinations, printer configuration components, and so forth. Network imaging extension 162 can be implemented in any of a wide variety of manners, such as an application programming interface (API) providing methods that can be called by content 161 and used to interact with servers 154 and 156 (e.g., to load, save, modify, delete, etc. documents).

Network server 154 executes a network-based imaging service 164 that allows a user of browser 160 to interact with his or her personal imaging repository (e.g., add, remove, and/or modify graphics in the repository) and identify an image for printing. Images identified or selected for including in the user's personal imaging repository can be indicated by value (e.g., the actual image data) or by reference (e.g., a pointer to or identifier of the image stored elsewhere). The image to be printed can be made up of graphics from one or more different graphic sources, and include any type of printable data (e.g., text, graphics, and so forth).

Network-based imaging service 164 represents one or more services accessible to imaging client 152. Each service can execute on the same server or alternatively on multiple different servers. These different services can provide different functionality (e.g., one service may be responsible for graphic storage and retrieval functionality, while another service is responsible for merge functionality allowing graphics to be merged together). Additionally, some services may be fully or partially overlapping in functionality provided by other services, allowing a degree of fault-tolerance to be built into system 150 (e.g., one service can take over the responsibilities of another if the other fails).

The graphic for an image is received from a graphic store 168 and/or a composition store 170. Graphic store 168 stores individual graphics (also referred to as documents or more generally data capable of being represented as a two dimensional graphic), such as individual files. These individual graphics in store 168 can be used as individual printable images via imaging service 164. Each individual graphic can be any of one or more types of printable data (e.g., text, pictures, etc.), and may result in multiple hard copy pages when printed. Additionally, a user of browser 160 may identify multiple individual graphics from graphic store 168 that are to be compiled together as a single image for printing. In this situation, network-based imaging service 164 provides an interface that allows the user of browser 160 to select different individual images and store the compilation of individual images as a single composition document (also referred to as a composition image) in composition store 170. The composition document may include the actual data from the individual images, or alternatively identifiers (e.g., file name and path, or Uniform Resource Locators (URLs)) of where the individual images can be retrieved for printing or displaying to the user.

Graphic store 168 and composition store 170 are illustrated in system 150 as two separate stores. Alternatively, multiple such stores may exist in system 150, and one or more graphic stores may be combined with one or more composition stores. Additionally, one or more of these stores 168 or 170 may be implemented on one of servers 154 or 156, and/or imaging client 152.

Network-based imaging service 164 also provides an interface via which a user of browser 160 can select one or more print options for printing (e.g., duplex/simplex, number of copies, print quality, etc.), including requesting private printing and optionally setting a PIN for private printing. Imaging client 152 also optionally includes an identity sensor 163 that automatically determines the identity of the user that selected private printing. Subsequently, during printing, the user's identity and/or the PIN set by the user is input to the printer or other device representing the printer before it will print the requested document. The selected print options can be pre-defined by the user and stored for subsequent print requests (e.g., at server 154, or alternatively elsewhere in system 150, such as in user profile 172 or at client 152), or alternatively set at the time of printing.

In order to print an image, the user identifies the image (optionally selecting graphics that are to be part of the image) via network-based imaging service 164. A print request including the image data is then communicated to network-based print server 166 executing on network server 156. Upon receipt of the print request, network-based printer server 166 interacts with a printer 174 coupled thereto to produce a hard copy of the image. If the user has enabled private printing, then server 166 (or alternatively printer 174) delays printing of the requested document until the user is in close physical proximity to printer 174.

The determination of when a user is in close physical proximity to printer 174 can be carried out in a variety of manners. For example, a user may be required to actuate a particular button(s) or key(s) on printer 174 or server 156, such as entry of the correct PIN. In addition to such manual entries by the user, the user's identity may also be automatically detected by a proximity sensor 176 located in server 156 (or alternatively printer 174). Proximity sensor 176 automatically detects a device associated with the user, such as a magnetic card, smart card (or other device with an embedded integrated circuit), etc. and determines the user is in close physical proximity when that device is detected close-by. Depending on the manner in which proximity sensor 176 and the user's device are implemented, this may require the user placing the device very close to the printer (e.g., swiping the card through a card reader so that a magnetic strip can be read, or simply holding the card close to a card reader), or alternatively the user's device may broadcast a signal with a particular range that is sensed by proximity sensor 176.

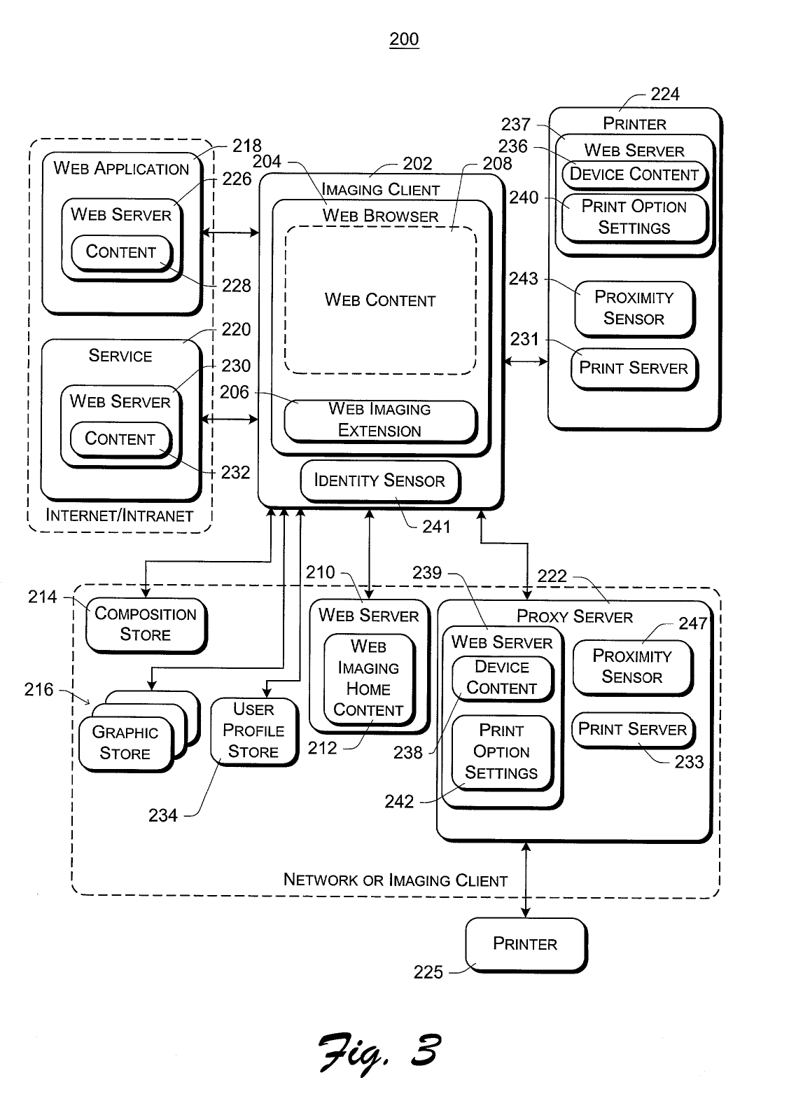

FIG. 3 illustrates an exemplary web-based architecture 200 in which private printing can be used. Web-based architecture 200 refers to the World Wide Web (or simply the Web), which is a distributed collection of interlinked, user-viewable documents (typically referred to as Web documents or Web pages) that are accessible via the Internet. The Web also refers to the client and server components which provide user access to such documents using standardized Internet protocols. Currently, the primary standard protocol for allowing applications to locate and acquire Web documents is the HyperText Transport Protocol (HTTP), and the Web pages are encoded using a standard markup language such as the HyperText Markup Language (HTML) or eXtensible Markup Language (XML). Alternatively, other protocols or languages may be used.

In architecture 200, an imaging client 202 (e.g., imaging client 152 of FIG. 2) includes a web browser 204 including a web imaging extension 206. Browser 204 is able to load and execute web content 208 (e.g., JavaScripts, Java applets or other web programs) from various sources. In the illustrated example, web browser 204 establishes a communication channel or connection with web server 210, causing web imaging home content 212 to be copied to imaging client 202 as at least part of web content 208 (and displayed, for example, as a web page). Although illustrated as being copied from web server 210, it is to be appreciated that web imaging home content 212 could alternatively be loaded from a local or intermediary source, such as a cache (not shown) implemented on imaging client 202. Additionally, any inputs by the user to web content 208 are typically handled by web content 208 rather than being returned to web imaging home content 212.

Once loaded in web browser 204, web content 208 can communicate, via web imaging extension 206, with other components in architecture 200, allowing access to a personal imaging repository as well as imaging sources and imaging destinations. In the illustrated example, the personal imaging repository includes composition store 214 and graphic store 216, the imaging sources include web application 218 and service 220, and the imaging destinations include proxy server 222 and printer 224. Web application 218 includes a web server 226 that maintains (or obtains/creates) content 228 accessible to web content 208. Similarly, service 220 maintains a web server 230 that maintains (or obtains/creates) content 232 accessible to web content 208. The content 228 and 232, when generated (e.g., from a file or dynamically) and executed on imaging client 202 (e.g., as part of web content 208), can make various functionality available to web content 208, such as image sources, combine multiple graphics into a composition document, etc.

Printer 224 and proxy server 222 each optionally include a print server 231 and 233 for queuing and managing received print requests, and a web server 237 and 239 storing or dynamically generating device content 236 and 238, respectively. Device content 236 represents content (which may be generated dynamically) that is provided to the web browser 204 by the web server 237. Device content 236 is a web content available to imaging client 202 (e.g., displayed as a web page) that represents printer 224 and that can access the user's personal imaging repository. The device content 236, when downloaded and executed on client 202 (e.g., as part of web content 208), can access the stores 214 and 216 via web imaging extension 206 to obtain graphics and upload the graphics to printer 224 for printing, as well as allow a user to define print option configurations for printer 224. The printing is then handled by a module (e.g., print server 231) of printer 224, without requiring any printer driver for printer 224 to be installed at client 202. The upload to printer 224 is accomplished using existing conventional mechanisms (e.g., TCP/IP sockets and/or HTTP POST command(s)) that allow content executing within the browser to communicate with the server from which that content came. In the illustrated example, imaging extension 206 is only used to obtain graphics from the personal imaging repository, not to upload the graphics to the printer.

Device content 236 further allows the user of imaging client 202 to enable private printing for printer 224. By allowing private printing to be enabled via the service representing printer 224, no printer driver for printer 224 need be installed on imaging client 202. Private printing can be configured in a variety of different manners in system 200, such as the following: (1) the user of imaging client 202 may enter a PIN that is required to be entered at printer 224 prior to a requested document being printed; (2) the user's identity may be detected (e.g., automatically) at imaging client 202 and communicated to printer 224, and printer 224 will not print a requested document until that user's identity is input local to printer 224 (e.g., an input keypad, based on a device associated with the user such as a smartcard, etc.); (3) preceding examples (1) and (2) may be combined so that in order for a document to be printed at printer 224 the user's identity must be input local to printer 224 and another key actuated on the printer 224 (e.g., actuation of a “go” button, entering a PIN, etc.).

The enablement of private printing for printer 224 can be a pre-configuration of printer 224 by the user that is stored in system 200 (e.g., at printer 224 as part of print option settings 240, as part of user profile store 234, at imaging client 202, etc.), or alternatively may be made by the user while submitting the print request. The enablement of private printing (as well as any PIN number or user identity) can be communicated to printer 224 for storage, or alternatively stored by device content 236 when downloaded and executed on client 202 (as part of web content 208). Additionally, in embodiments where PINs are used, PINs may be user PINs (which relate to all print requests for a user) or print request PINs (which relate to only a single print request). Alternatively, multiple PINs may be included for each print request (e.g., one user PIN and one print request PIN).

In the case of user PINs, each user can define his or her own PIN and change it at any time (including after printing). The PIN number for the user can be changed via an interface presented by browser 204 based on device content 236 by accessing (e.g., browsing to) printer 224. Any print requests associated with that user then require the new PIN number to be entered at printer 224 for printing. In the case of print request PINs, each print request (also referred to as a print job) is assigned a PIN by the user. Different print requests can be assigned different PINs, but the user is required to enter the correct PIN for the particular print request in order for printer 224 to print the document for that print request.

In embodiments where the user's identity is automatically identified, an identity sensor 241 is included in imaging client 202 to automatically identify the user's identity. The user's identity is then stored for future print requests and/or used for the current print request. Although illustrated as a separate module, identity sensor 241 may be included in web imaging extension 206, or alternatively as part of device content 236 loaded by web browser 204.

Identity sensor 241 can automatically identify the user's identity in a variety of different manners. In one implementation, identity sensor 241 queries an operating system (not shown) executing on imaging client 202 for the log-on ID or name of the user currently logged-on to imaging client 202 at the time the print request is received. This log-on ID or name is used as the user's identity. In another implementation, the user has a smartcard or similar device (e.g., a card or device attached to his or her key chain, a piece of jewelry (such as a ring, watch, pendant, etc.), etc.) with his or her identity stored thereon (e.g., his or her name, employee number, email address, other identification number, etc.). The smartcard or similar device allows the identity to be communicated from the card or device to identity sensor 241. This can be accomplished via any of a wide variety of conventional communication media, but typically will be wireless media (e.g., RF, infrared, magnetic, etc.). The user's card or device may broadcast the user's identity, or alternatively wait to respond with the user's identity after it has received a query from a sensor (such as identity sensor 241).

When the user's identity is used as the basis (at least in part) for private printing, printer 224 delays printing requested documents until the user's identity is sensed by a proximity sensor 243 in printer 224. The sensing of the user's identity can be performed in a variety of manners, such as the user swiping his or her card or device through a card reader, or placing his or her card in close physical proximity to the sensor. It is to be appreciated that the range of sensor 243 and/or the user's card or device can vary by implementation, but typically should be such that the user is not sensed as being close until he or she is near enough to the printer to take the printed copy of his or her document before any other user is able to (e.g., within six feet).

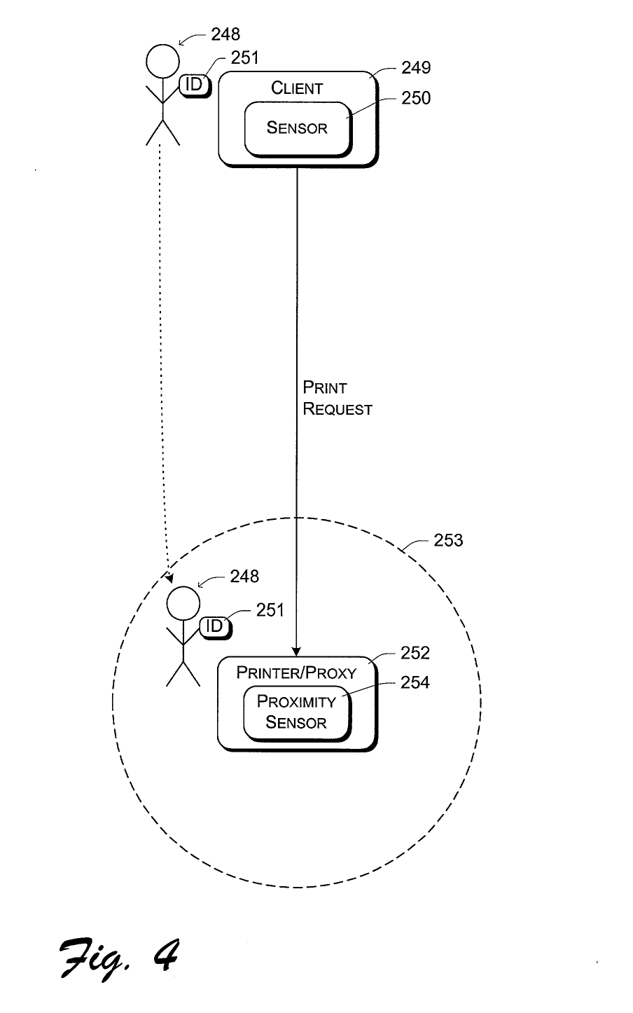

This situation is illustrated in additional detail in the example of FIG. 4. A user 248 of a client computing device 249 requests that a document be printed with private printing. A sensor 250 at client device 249 senses the user's identity from a smartcard or similar device 251. The print request is communicated to the printer (or proxy representing the printer) 252, which does not print the request until the user 248 is detected in close proximity to printer 252 due to the card or device 251 having the user's ID being moved within a communications range 253 of a proximity sensor 254 of printer 252.

Returning to FIG. 3, the communication of a PIN or user identity from imaging client 202 to printer 224 can be accomplished in either a secure or insecure manner. For insecure communication, any conventional communication protocol can be used (such as HTTP). For secure communication, any of a variety of conventional security protocols can be used to establish a secure connection between client 202 and printer 224, such as HTTPS (HyperText Transfer Protocol Secure), SSL (Secure Sockets Layer), IPSec (IP SECurity), and so forth.

Proxy server 222 allows a printer(s) that does not host a web server to be represented by a web service. Proxy server 222 includes device content 238 and web server 239, which operate analogous to device content 236 and web server 237, respectively. Proxy server 222 may also optionally include a proximity sensor 247 analogous to proximity sensor 243 of printer 224. The printer 225 is represented by device content 238 and graphics obtained by the device content 238 (presented in the context of the device). This device content, when downloaded and executed on client 202 (e.g., as part of web content 208), can upload graphics accessed through the imaging extension to proxy server 222, which in turn forwards these graphics to printer 225.

Web application 218 and service 220 may each be accessible by imaging client 202 via the Internet or via a local network (e.g., an Intranet). Each of the stores 214 and 216, as well as user profile store 234, web server 210, and proxy server 222, may be accessible via a network (e.g., an Intranet or the Internet) and/or located on imaging client 202.

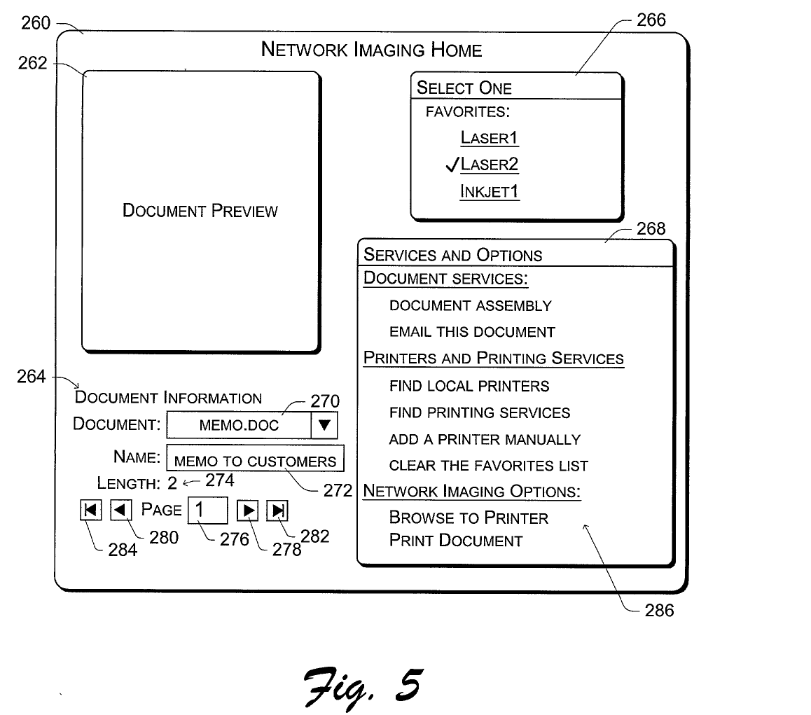

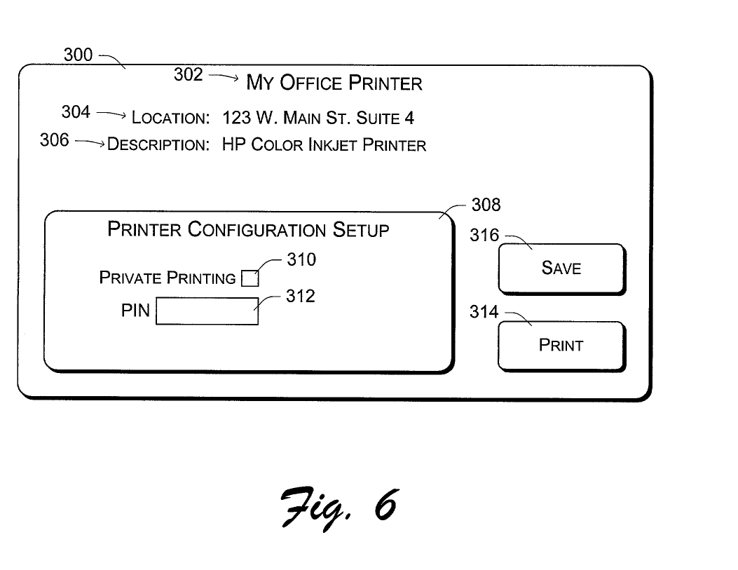

During operation, web content 208 generates and renders, via web browser 204, one or more user interfaces (e.g., graphical user interfaces (GUIs)) that allows the user to interact with his or her personal imaging repository. This interaction includes allowing the user to select images or documents for printing, and to set private printing options. Example user interfaces rendered by web content 208 are discussed below with reference to FIGS. 5-6. The various interfaces can be separate web pages, or alternatively portions of another (or the same) web page.

FIG. 5 illustrates an exemplary user interface presented by web browser 204 of FIG. 3. In the illustrated example, user interface 260 is displayed by web browser 204 as a result of loading the web imaging home content 212. User interface 260 includes a document preview window 262, a document information portion 264, a favorite printers portion 266, and a services and options portion 268. User interface 260 allows the user to select one or more documents for printing via document information portion 264. The user can select the desired document by name via a pull down menu input 270 or change the name of the selected document in name field 272. Alternatively, other document-selection input mechanisms may be supported, such as cutting and pasting of the document name, dragging and dropping an icon representing the document, supporting a “browse” feature allowing the user to search his or her personal imaging repository (or elsewhere) for documents, and so forth.

The length of the user-selected document (e.g., in pages) is illustrated in a length field 274. Document preview window 262 provides a location via which a small preview image of the document selected for printing (or other processing) is displayed to the user. A current page section 276 identifies the current page(s) being displayed in document preview window 262, and page manipulation buttons 278, 280, 282, and 284 allow the user to easily advance to the next page in the document, the previous page in the document, the last page of the document, or the first page of the document, respectively.

Favorite printers portion 266 identifies one or more printers that are selectable by the user for printing, and can include, for example, the user's preferred printers, suggested printers to be used by the user, default printers, and so forth. In the illustrated example, each printer identified in favorites portion 266 is identified by a hyperlink (illustrated as being underlined). The user can select one of the printers that the identified document is to be printed on by activating the hyperlink (e.g., by using a pointer control device to situate a pointer over the hyperlink on screen and click a button of the control device). Additionally, selecting the hyperlink of a printer in portion 266 accesses a web page for that printer, allowing the user to define print options such as private printing.

Services and options portion 268 allows the user to identify or request options or services, such as to add a printer to favorites portion 266, clear favorites portion 266, print the document, and so forth.

One option that can be selected by the user via portion 268 is the browse to printer option 286, which allows the user to access web pages for printers that are not listed in portion 266 (and optionally those printers listed in portion 266, although accessing them via portion 266 is typically more user-friendly). Selection of the browse to printer option 286 allows the user to select a particular printer (e.g., by user input of the printer name or Uniform Resource Locator (URL) to identify the printer or print service, or by displaying to the user a directory or listing (e.g., via a web page) of available printers) to be browsed to in order to enable private printing.

In one implementation, the enabling of private printing for a printer is a print option that applies to all printing to that printer by the user. Alternatively, the user may set different print option configurations, different ones of which include different print option settings (which may or may not include, at the user's discretion, the enablement of private printing). Additional discussions regarding the setting of print option configurations can be found in co-pending U.S. patent application Ser. No. 09/905,238, filed Jul. 12, 2001, entitled “Print Option Configurations Specific to a Service or Device for Printing in a Distributed Environment”, to inventors Shell S. Simpson, Ward S. Foster, and Kris R. Livingston, which is hereby incorporated by reference.

FIG. 6 illustrates an exemplary printer configuration setup user interface 300. Interface 300 includes the name 302 of the printer, a physical location 304 of the printer, and a description 306 of the printer. Interface 300 is presented to the user when he or she browses to the printer or service representing the printer, such as by selection of one of the hyperlinks in portion 266 in FIG. 5, or by entering the URL of the printer or service into web browser 204 of FIG. 3. This browsing may be performed by the user when he or she is pre-configuring the printer for subsequent printing, or alternatively during the process of submitting a print request.

Interface 300 also includes a printer configuration setup portion 308. Printer configuration setup portion 308 includes a private printing enablement checkbox 310 and a PIN data input field 312 via which the user can input a PIN. The user can toggle between enabling and disabling private printing by repeatedly selecting checkbox 310. Checkbox 310 is a conventional checkbox that indicates when it has been selected (e.g., by including an “x” or other indication in checkbox 310). In one implementation checkbox 310 is automatically selected when one or more characters are input to PIN data field 312. Alternatively, rather than a checkbox or data input field, private printing may be enabled via any other of a wide variety of conventional user interface mechanisms. It should be noted that other conventional print options may also be set via setup portion 308 (e.g., duplex printing, number of copies to be printed, print quality, etc.), however these additional options have not been illustrated in FIG. 6 in order to avoid cluttering the drawings.

Interface 300 optionally includes a print button 314 and/or a save button 316. Selection of a print button 314 causes the requested document (identified in preview window 262 and document information portion 264 of FIG. 5) to be printed using private printing (if enabled) and the PIN supplied in setup portion 308. In the illustrated example, by selecting print button 314, the user is inherently requesting that the private printing options (enablement and possibly PIN) entered in setup portion 308 are for the current print request only and are not save for use with subsequent print requests. Selection of save button 316, on the other hand, causes the private printing options entered in setup portion 308 to be saved and used by the printer for subsequent print requests.

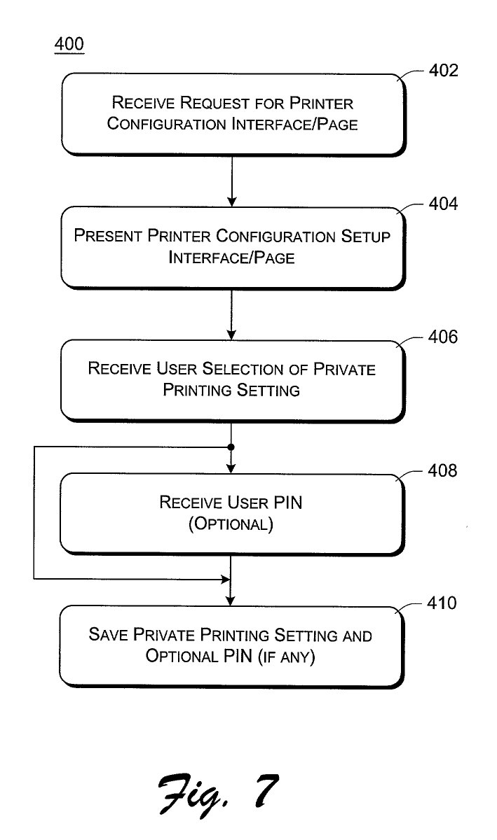

FIG. 7 is a flowchart illustrating an exemplary process 400 for configuring private printing. The process of FIG. 7 is performed by device content from a printer or print service and involves interaction between the client and the printer or print service. The process 400 may optionally be implemented in software.

Initially, a request (e.g., from a user) is received for a printer configuration interface or page (act 402). In response to the request, a printer configuration setup interface (e.g., a web page) is presented for display to the user (act 404). The user selection of the private printing option (whether it is enabling of private printing or disabling of private printing) is then received (act 406), as is optionally a user-input PIN for private printing (act 408). The user selection of the private printing option is then saved, as is any received PIN (act 410). Alternatively, as discussed above, the selected private printing options may not be saved for subsequent print requests.

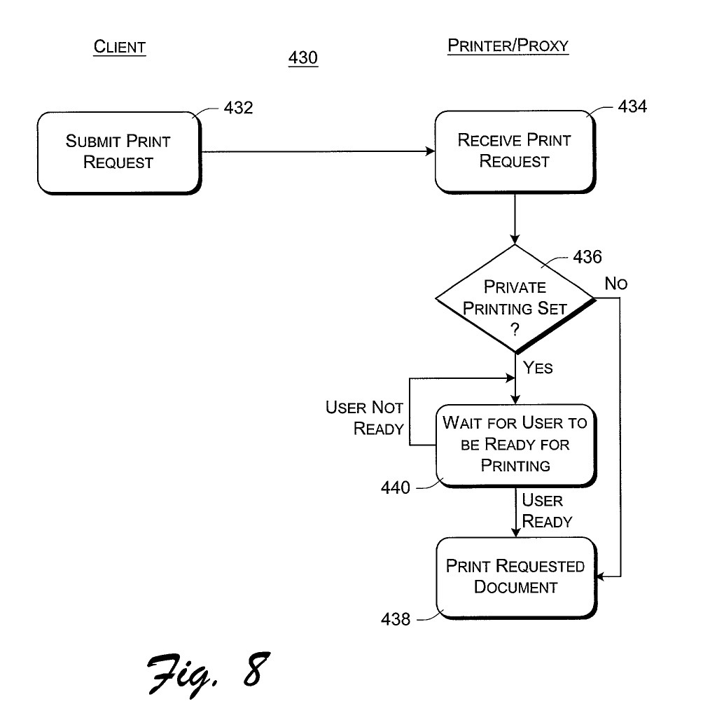

FIG. 8 is a flowchart illustrating an exemplary process 430 for printing using private printing. Different parts of the process of FIG. 8 are performed at the client and the printer (or proxy representing the printer). Acts performed by the client are illustrated on the left-hand side of FIG. 8, while acts performed by the printer (or proxy) are illustrated on the right-hand side of FIG. 8. The process 430 may optionally be implemented in software.

Initially, a print request is submitted by the client (act 432). Private printing may have been enabled for this print request (following the process discussed above with reference to FIG. 7) either as part of the process of submitting the print request or as a pre-configuration process. Regardless, the print request is received at the printer/proxy (act 434). A check is then made as to whether private printing is set (act 436). If private printing is not set, then the requested document is printed (act 438). However, if private printing is set then the printer/proxy waits for the user to be ready for printing (act 440). As discussed above, this can be determined in a variety of manners, such as detection of the user identity in close proximity to the printer/proxy, entry of a PIN, etc. Once the user is ready for printing of the document, the document is printed (act 438).

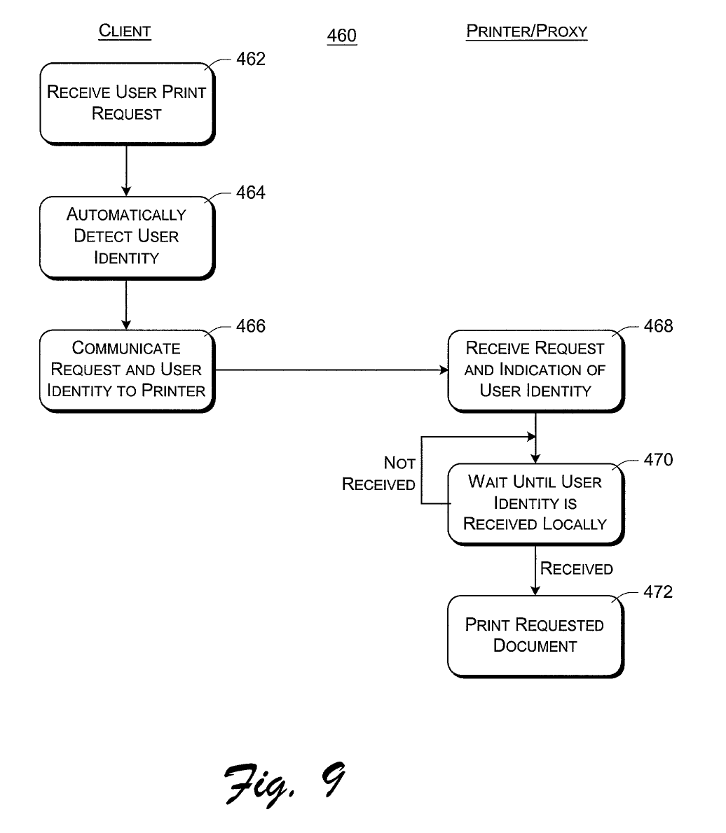

FIG. 9 is a flowchart illustrating an exemplary process 460 for automated printing using private printing. Different parts of the process of FIG. 9 are performed at the client and the printer (or proxy representing the printer). Acts performed by the client are illustrated on the left-hand side of FIG. 9, while acts performed by the printer (or proxy) are illustrated on the right-hand side of FIG. 9. The process 460 may optionally be implemented in software.

Initially, the client receives a user print request (act 462). An identity sensor on the client automatically detects the user identity (act 464) and the client communicates both the user identity and the print request to the printer/proxy (act 466).

The printer/proxy receives the user identity and the print request (act 468), then waits until the user identity is received locally (act 470). This local reception of the user identity could be an automatic sensor sensing a smartcard or similar device, or alternatively manual user input of the user identity (e.g., through an alphanumeric or numeric keypad). Once the user identity is received locally, the user is determined to be in close proximity to the printer and the requested document is printed (act 472).

In the discussions above, private printing is discussed primarily with reference to a particular user. However, it is to be appreciated that the printer is able so support multiple different PINs and/or user identities concurrently. Thus, multiple users are able to submit print requests with private printing enabled to the same printer concurrently, and each user's print request will be printed by the printer when that user is in close proximity to the printer (e.g., the user's identity is sensed by the printer or the user-selected PIN is input).

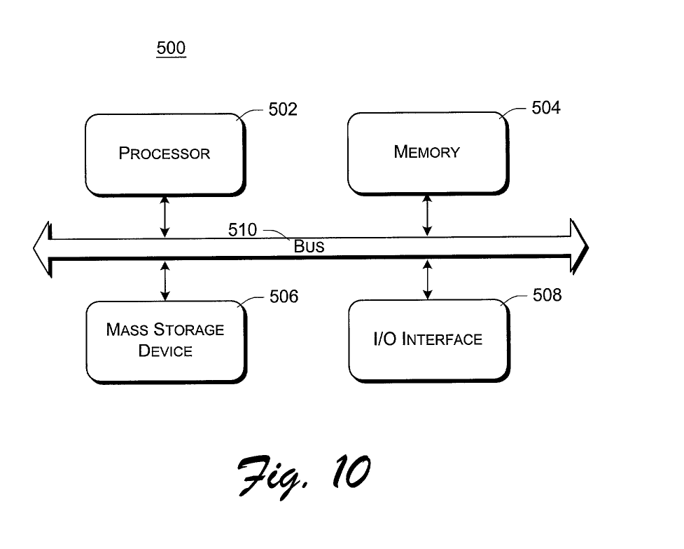

FIG. 10 illustrates an exemplary computer system 500 in additional detail. Computer system 500 can be, for example, a network client 102 of FIG. 1, an imaging client 152 or server 154 or 156 of FIG. 2, an imaging client 202, server 210 or 222 of FIG. 3, etc. Computer system 500 represents a wide variety of computing devices, such as desktop computers, portable computers, dedicated server computers, multi-processor computing devices, cellular telephones, personal digital assistants (PDAs), handheld or pen-based computers, microcontroller-based electronic devices, gaming consoles, and so forth.

Computer system 500 includes a processor 502, a memory 504, a mass storage device 506, and an input/output (I/O) interface 508, all coupled to a bus 510. Bus 510 represents one or more buses in computer system 500, such as a system bus, processor bus, accelerated graphics port (AGP), peripheral component interconnect (PCI), and so forth. The bus architecture can vary by computing device as well as by manufacturer. I/O interface 508 is a conventional interface allowing components of system 500 (e.g., processor 502) to communicate with other computing devices via a network, such as network 158 of FIG. 2. I/O interface 508 may be, for example, a modem, a network interface card (NIC), and so forth.

Memory 504 represents volatile and/or nonvolatile memory used to store instructions and data for use by processor 502. Typically, instructions are stored on a mass storage device 506 (or nonvolatile memory) and loaded into a volatile memory 504 for execution by processor 502. Additional memory components may also be involved, such as cache memories internal or external to processor 502. Various embodiments of the invention may be implemented, at different times, in any of a variety of computer readable media that is part of, or readable by, system 500. For example, such computer readable media may be mass storage device 506, memory 504 or a cache memory, a removable disk (not shown) that is accessible by processor 502 or another controller of system 500 (such as a magnetic disk or optical disk), and so forth.

Computer system 500 is exemplary only. It is to be appreciated that additional components (not shown) can be included in system 500 and some components illustrated in system 500 need not be included. For example, a display adapter, additional processors or storage devices, additional I/O interfaces, and so forth may be included in system 500, or mass storage device 506 may not be included.

I/O interface 508 is a conventional interface allowing components of system 500 (e.g., processor 502) to communicate with other computing devices via a network, such as network 158 of FIG. 2.

The discussions herein refer primarily to software components and modules that can be executed by a computing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method, implemented on a client computing device, the method comprising:
displaying a web page representing a printer to a user, the web page including a user-selectable option to enable private printing on the printer;
receiving a user selection of the option to enable private printing; and
communicating the user selection to the printer.

2. A method as recited in claim 1, wherein receiving the user selection comprises receiving the user selection of the option to enable private printing in the absence of a printer driver, on the client computing device, that supports private printing.

3. A method as recited in claim 1, wherein communicating comprises communicating the user selection to a proxy server that represents the printer.

4. A method as recited in claim 1, wherein receiving the user selection comprises receiving user-input of a personal identification number (PIN) that is to be subsequently entered at the printer in order to print a document, requested by the user, at the printer.

5. A method as recited in claim 4, wherein the PIN corresponds to a single print request.

6. A method as recited in claim 4, wherein the PIN corresponds to a single user and multiple print requests for the single user.

7. A method as recited in claim 1, wherein communicating comprises communicating the user selection to the printer via a secure connection.

8. A method as recited in claim 1, further comprising:
automatically identifying a user identity of the user; and
communicating the user identity to the printer.

9. A method as recited in claim 1, wherein the receiving comprises receiving the user selection prior to receiving a print request to be communicated to the printer.

10. A method comprising:
receiving, at a web service representing a printer, a request to print a document;
receiving, at the web service, an identification of the user;
automatically detecting when the user is in close physical proximity to the printer; and
waiting to print the document until the user is in close physical proximity to the printer.

11. A method as recited in claim 10, wherein automatically detecting when the user is in close physical proximity to the printer comprises detecting when the user is within a threshold distance of the printer, wherein the threshold distance is no greater than a range of a proximity sensor that is part of the printer.

12. A method as recited in claim 10, wherein the web service is embedded in the printer.

13. A method as recited in claim 10, wherein the web service is included in a proxy coupled to the printer.

14. A method as recited in claim 10, wherein waiting to print the document further comprises waiting to print the document until the user has selected a particular one or more buttons on the printer.

15. A method as recited in claim 10, wherein waiting to print the document further comprises waiting to print the document until the user has entered a particular personal identification number (PIN) at the printer.

16. A method as recited in claim 15, wherein the web service receives the PIN from the same computing device as the request to print the document is received from.

17. A method as recited in claim 10, wherein the receiving comprises receiving the identification of the user from a client computing device being used by the user, and wherein no printer driver for the printer is installed on the client computing device.

18. One or more computer readable media having stored thereon a plurality of instructions that, when executed by one or more processors of a computing device, causes the one or more processors to perform acts including:
displaying, based on device content received from a network service, an interface including a user-selectable option to enable private printing on a printer represented by the network service;
receiving, from a user of the computing device, a selection of the option to enable private printing; and
sending the user selection to the printer to be used in printing a print request from the user.

19. One or more computer readable media as recited in claim 18, wherein receiving the selection comprises receiving, from the user of the computing device, the selection of the option to enable private printing without a printer driver, for the printer, that supports private printing being installed on the computing device.

20. One or more computer readable media as recited in claim 18, wherein receiving the selection comprises receiving user-input of a personal identification number (PIN) that is to be subsequently entered at the printer in order to print a document, requested by the user, at the printer.

21. One or more computer readable media as recited in claim 18, wherein the plurality of instructions further cause the one or more processors to perform acts including:
automatically identifying an identity of the user; and
sending the identity to the printer with the user selection.

22. A system comprising:
a network service representing a printer;
a client computing device configured to,
execute a network browser via which content representing a printer can be displayed to allow a user of the client computing device to request a document to be printed at the printer,
automatically detect an identity of the user,
communicate the print request and the identity of the user to the network service; and
wherein the network service is configured to,
receive the print request and the identity of the user,
automatically detect when the user is in close physical proximity to the printer by identifying the identity of the user being located on a device within a range of a proximity sensor at the network service, and
waiting to print the requested document until the user has been detected in close physical proximity to the printer.

23. A system as recited in claim 22, wherein the network service is embedded in the printer.

24. A system as recited in claim 22, wherein the network service is embedded in a proxy server coupled to the printer.

25. A system as recited in claim 22, wherein the content representing the printer can be displayed to allow a user of the client computing device to enable a private printing option along with the request for the document to be printed.

26. A system as recited in claim 22, wherein automatically detecting the identity of the user comprises querying an operating system of the client computing device for the identity.

27. A system as recited in claim 22, wherein automatically detecting the identity of the user comprises using a proximity sensor that is part of the client computing device to identify the user identification from a device worn by the user.
